(19) United States
(12) Patent Application Publication
(10) Pub. No.: US 2009/0066249 A1
(43) Pub. Date: Mar. 12, 2009

(54) Display panel and associated methods

(76) Inventors: Chul-Hong Kim, Suwon-si (KR); Yeon-Joo Choi, Suwon-si (KR); Hyun-Mi Jeong, Suwon-si (KR); Soon-Rewl Lee, Suwon-si (KR)

Correspondence Address: LEE & MORSE, P.C., SUITE 500, 3141 FAIRVIEW PARK DRIVE, FALLS CHURCH, VA, 22042, US

(21) Appl. No.: 12/230,985

(22) Filed: Sep. 9, 2008

(30) Foreign Application Priority Data
Sep. 12, 2007 (KR) 10-2007-0092764

(51) Int. Cl. H01J 17/49

(52) U.S. Cl. 313/584

(57) ABSTRACT

A display panel includes a first substrate having a plurality of address electrodes, and a second substrate having a plurality of display electrodes that include bus electrodes, the first and second substrates being arranged opposite to each other. The bus electrodes may include a mixture of a chromophore element and an electrically conductive metal, the chromophore element including at least one of a transition element and a rare earth element metal.

### BACKGROUND OF THE INVENTION

1. Field of the Invention

Embodiments relate to a display panel that has low external light luminance and good electrical conductivity, and includes a black-white integral bus electrode, and associated methods.

2. Description of the Related Art

A plasma display panel may include a pair of display electrodes disposed on a front substrate and an address electrode disposed on a rear substrate, the rear substrate being spaced apart from the front substrate. A discharge cell may correspond to the pair of display electrodes and the address electrode. An image produced by the plasma display panel may be viewed through the front substrate.

A bus electrode of a display electrode may have two layers, i.e., a black electrode layer and a white electrode layer. The black electrode layer may be colored black to absorb external light entering the front substrate, in order to lower external light luminance. The plasma display panel may be manufactured using a process that includes a lithographic operation, e.g., including exposure of a photosensitive material and developing the exposed material to pattern the bus electrode. In such a manufacturing process, formation of a double-layered bus electrode may require many complex and time-consuming operations, e.g., printing, drying, exposing, developing, and firing a white electrode paste. Further, if the production of a bus electrode is not appropriately controlled during the exposing and developing processes, edge curl may result, thereby negatively influencing the quality of the resulting product.

In addition to the above, increasing the resolution of the plasma display panel may require decreasing the size of a discharge cell. Accordingly, electrodes for the discharge cell may need to be made narrower and arranged more closely to one another. Accordingly, there is a need for a simple process for forming a bus electrode that affords the advantages of a double-layered electrode, e.g., low reflectivity and high electrical conductivity, without requiring the complex manufacturing operations associated with a double-layered electrode.

### SUMMARY OF THE INVENTION

Embodiments are therefore directed to a display panel and associated methods, which substantially overcome one or more of the problems due to the limitations and disadvantages of the related art.

It is therefore a feature of an embodiment to provide a plasma display panel that includes an integral black-white bus electrode, and associated methods.

It is therefore another feature of an embodiment to provide a plasma display panel that includes an integral black-white bus electrode formed as a single layer that includes a mixture of a chromophore element and an electrically conductive metal, the chromophore element including at least one of a transition element and a rare earth element metal, and associated methods.

At least one of the above and other features and advantages may be realized by providing a display panel, including a first substrate having a plurality of address electrodes, and a second substrate having a plurality of display electrodes that include bus electrodes, the first and second substrates being arranged opposite to each other. The bus electrodes may include a mixture of a chromophore element and an electrically conductive metal, the chromophore element including at least one of a transition element and a rare earth element metal.

The chromophore element may include at least one of Co, Fe, Ru, Re, Rh, Os, and Ir as the transition element. The chromophore element may include at least one of Sc and Y as the rare earth element metal. The electrically conductive metal may include at least one of Ag, Au, Al, Cu, Ni, Cr, Zn, Sn, and an Ag—Pd alloy.

Each bus electrode may be a single layer, the single layer including the mixture of the chromophore element and the electrically conductive metal. The chromophore element may be mixed with the electrically conductive metal as a mixture rather than as a complete solid-solution. The electrically conductive metal may have a particle size (D50) of about 1 to about 3 μm. The chromophore element may have a particle size (D50) of about 0.5 to about 2 μm.

The mixture may include about 0.04 to about 0.6 parts by weight of the chromophore element, based on 100 parts by weight of the electrically conductive metal. A concentration of the chromophore element in the bus electrodes may increase toward the second substrate. About 75 to about 100 wt % of the chromophore element in the bus electrodes may be in a lower half-height of the bus electrodes, the lower half-height of the bus electrodes being the half-height closest to the second substrate.

The bus electrodes may further include an inorganic binder that includes glass frit. The chromophore element may be disposed in the glass frit as a colorant, and the colored glass frit may be mixed with the electrically conductive metal. The glass frit may include about 1 to about 5 parts by weight of the chromophore element, based on 100 parts by weight of the glass frit. A concentration of the glass frit colored with the chromophore element in the bus electrodes may increase toward the second substrate. About 75 to about 100 wt % of the glass frit colored with the chromophore element in the bus electrodes may be in a lower half-height of the bus electrodes, the lower half-height of the bus electrode being the half-height closest to the second substrate. Substantially all of the glass frit colored with the chromophore element may be concentrated in a region of the bus electrodes that is closest to the second substrate. The region may occupy about 8 to about 16% of the height of the bus electrodes. The bus electrode may include about 4 to about 11 parts by weight of the glass frit colored with the chromophore element based on 100 parts by weight of the electrically conductive metal. The glass frit may include at least one of a bismuth-based glass frit and a zinc-based glass frit.

At least one of the above and other features and advantages may also be realized by providing a method of fabricating a display panel, the method including forming a first substrate to have a plurality of address electrodes, forming a second substrate to have a plurality of display electrodes that include bus electrodes, and arranging the first and second substrates opposite to each other. The bus electrodes may be formed by patterning a paste into a predetermined pattern, and the paste may include a mixture of a chromophore element and an electrically conductive metal, the chromophore element including at least one of a transition element and a rare earth element metal.

At least one of the above and other features and advantages may also be realized by providing a method of fabricating a display device, the method including providing a display panel, coupling the display panel to at least one display driving circuit, and enclosing the display panel in a housing. The display panel may include a first substrate having a plurality of address electrodes and a second substrate having a plurality of display electrodes that include bus electrodes, the first and second substrates being arranged opposite to each other, and the bus electrodes may include a mixture of a chromophore element and an electrically conductive metal, the chromophore element including at least one of a transition element and a rare earth element metal.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a plasma display panel according to an embodiment;

FIG. 2 illustrates a scanning electron microscope (SEM) photograph of the top of a bus electrode of Example 2 according to an embodiment; and

FIG. 3 illustrates a SEM photograph of a cross-sectional view of the bus electrode of FIG. 2.

### DETAILED DESCRIPTION OF THE INVENTION

Korean Patent Application No. 10-2007-0092764 filed on Sep. 12, 2007, in the Korean Intellectual Property Office, and entitled: “Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under the other layer, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a chromophore element” may represent a single element, e.g., cobalt, or multiple elements in combination, e.g., yttrium mixed with cobalt and iron.

An embodiment may provide a plasma display panel including first and second substrates arranged opposite to each other, a plurality of address electrodes disposed on the first substrate, and a plurality of display electrodes disposed in a direction crossing the address electrodes, the display electrodes including bus electrodes.

### Composition of Bus Electrode

The bus electrode may include a chromophore element mixed with an electrically conductive metal. The chromophore element may include a transition element, a rare earth element metal, or a combination thereof. The bus electrode may be formed as a single layer, yet may provide performance equivalent to a double-layered bus electrode that includes a conventional dark layer.

The chromophore element and the electrically conductive metal may be combined as a mixture, rather than as a complete solid solution. The chromophore element may be mono-dispersed when preparing a paste for a bus electrode, such that the chromophore element and the electrically conductive metal exist as a mixture without phase change.

The transition element included in the chromophore element may be, e.g., Co, Fe, Ru, Re, Rh, Os, Ir, or a combination thereof. The rare earth element metal may be, e.g., Sc, Y, or a combination thereof. In the bus electrode, the transition element may be combined with the rare earth element metal.

The electrically conductive metal may be, e.g., silver (Ag), gold (Au), aluminum (Al), copper (Cu), nickel (Ni), chromium (Cr), zinc (Zn), tin (Sn), a silver-palladium (Ag—Pd) alloy, or a combination of such metals. Among these, Ag may provide the best electrical conductivity.

The electrically conductive metal may have a particle size (D50) of about 1 to about 3 μm. If an electrically conductive metal with a size of less than about 1 μm is used to prepare a paste for the bus electrode, the electrically conductive metal may have an increased degree of dispersion and may not provide a desired viscosity. If the electrically conductive metal has a size of more than about 3 μm, the bus electrode may exhibit a deteriorated pattern.

The chromophore element may have a particle size (D50) of about 0.5 to about 2 μm. When the chromophore element with a size in this range is used to prepare a paste, it may exhibit the best mono-dispersion.

The bus electrode may include the chromophore element in an amount of about 0.04 to about 0.6 parts by weight, based on 100 parts by weight of the electrically conductive metal. If the chromophore element is included in an amount of less than about 0.04 parts by weight, the bus electrode may not be sufficiently black, which may result in a white electrode line. If the chromophore element is included in an amount of more than about 0.6 parts by weight, the electrical conductivity of the bus electrode may be reduced.

In an implementation, a concentration of the chromophore element in the bus electrode may increase toward the second substrate, i.e., a concentration of the chromophore element in the portion of the bus electrode closest to the second substrate may be greater than a concentration of the chromophore element in a portion of the bus electrode farthest from the second substrate. The chromophore element may be darker than the electrically conductive metal and, when the bus electrode is formed as a single layer, the bus electrode may exhibit performance characteristics similar to those of a double-layered electrode. Accordingly, the bus electrode may be formed as a single layer and may be prepared in a simple process, while still exhibiting low external light luminance and good electrical conductivity.

When the chromophore element has an increased concentration toward the second substrate, about 75 to about 100 wt % of the chromophore element may be in the bottom half of the bus electrode. Herein, the bottom half of the bus electrode indicates the half of the height of bus electrode closest to the second substrate. When about 75 to about 100 wt % of the chromophore element is in the bottom half-height of the bus electrode, the bus electrode formed as a single layer may exhibit performance characteristics similar to those of a double-layered bus electrode, since the chromophore element may be darker than the electrically conductive metal.

In an embodiment, the bus electrode may additionally include an inorganic binder including glass frit. When the chromophore element is mixed with the electrically conductive metal, it may impart color to the glass frit. In an implementation, the glass frit colored with the chromophore element may have a concentration that increases toward the second substrate, i.e., the concentration of the colored frit glass, relative to the electrically conductive metal, may increase closer to the second substrate. Thus, the glass frit colored with the chromophore element may be more heavily disposed in the portion of the bus electrode that is closest to the second substrate.

The chromophore element used to color the glass frit may be present in the glass frit in an amount of about 1 to about 5 parts by weight, based on 100 parts by weight of the glass frit. If the chromophore element is included in an amount less than about 1 part by weight, it may not provide a black color. If the chromophore element is included in an amount more than about 5 parts by weight, the electrical conductivity of the bus electrode may be significantly reduced.

The glass frit colored with the chromophore element may be increasingly concentrated toward the second substrate. In an implementation, the colored glass frit may exist at the bottom of the bus electrode in an amount of about 75 to about 100 wt % based on the entire weight of the glass frit, i.e., about 75 to about 100 wt % of the colored glass frit may be in the bottom half-height of the bus electrode. When about 75 to about 100 wt % of the glass frit colored with the chromophore element exists in the bottom half-height of the bus electrode, the bus electrode may formed as a single layer while exhibiting the performance characteristics of a double-layered electrode.

In another embodiment, the bus electrode may include a region in which the glass frit colored with a chromophore element is concentrated, the region of concentration being on the side of the bus electrode that contacts the second substrate, i.e., the side closest to the second substrate. The concentrated region of the glass frit colored with the chromophore element may consist primarily of the glass frit colored with the chromophore element, but may also include a small amount of the electrically conductive metal, binder, solvent, carbon residue, etc., i.e., a small amount of the other materials that make up the bus electrode.

When the bus electrode includes the concentrated region of the glass frit colored with the chromophore element, the bus electrode may have a structure that exhibits performance characteristics similar to those of a double-layered electrode, even when the bus electrode is formed as a single layer. Thus, the bus electrode may exhibit low external light luminance and good electrical conductivity, while being formed as a single layer using simple preparation process.

When the bus electrode includes the concentrated region of the glass frit colored with the chromophore element, the concentrated region may occupy about 8 to about 16% of the entire height of the bus electrode. In an implementation, the bus electrode may have a height of about 5 to about 6 μm, and the concentrated region of the glass frit colored with the chromophore element may occupy about 0.5 to about 0.8 μm of the 5-6 μm height.

The bus electrode may include the glass frit colored with the chromophore element in an amount of about 4 to about 11 parts by weight, based on 100 parts by weight of the electrically conductive metal in the bus electrode. If the glass frit colored with the chromophore element is included in an amount less than about 4 parts by weight, it may not provide a black color. If the glass frit colored with the chromophore element is included in an amount more than about 11 parts by weight, the electrical conductivity of the bus electrode may be significantly reduced.

The glass frit may include, e.g., a bismuth-based glass frit, a zinc-based glass frit, and combinations thereof. The glass frit may include a glass frit generally used for manufacturing a conventional electrode.

### Preparation of Bus Electrode

The bus electrode may be prepared using a generally-known process such as a photo-etching process, a lift-off process, a photosensitive paste process, a direct printing process, or using transfer materials technology (TMT). Among these processes, the photosensitive paste process may be most appropriate. In other implementations, the bus electrode may be prepared using a sheet process using a transfer film, a photosensitive tape process, or a material transfer process.

The glass frit colored with the chromophore element may be mixed with the electrically conductive metal and a vehicle to form a paste. The glass frit colored with the chromophore element may be prepared by adding a chromophore element thereto when the glass frit is wet blending.

The bus electrode may be fired after being patterned. In an embodiment, the bus electrode may be fired while the glass frit is sinking down to the bottom of the bus electrode. The manufacturing process may include regulating the amount of the chromophore element or the amount of glass frit colored with the chromophore element, relative to the amount of the electrically conductive metal, regulating the size of the chromophore element and/or the size of the electrically conductive metal, regulating the firing conditions, etc. The bus electrode may be prepared to have a concentration of the chromophore element or the glass frit colored with the chromophore element that increases toward the second substrate. In an embodiment, a colored glass frit portion of the bus electrode may be disposed between the remainder of the bus electrode and the second substrate. The amount of the chromophore element or amount of glass frit colored with the chromophore element, relative to the electrically conductive metal, and the sizes of the chromophore element and the electrically conductive metal, may be as described above.

The photosensitive paste process for manufacturing the bus electrode may include: a) preparing a photosensitive paste with a mixture of the chromophore element and the electrically conductive metal, b) forming a photosensitive coating layer by coating and drying the photosensitive paste on the second substrate including a transparent electrode, c) exposing the photosensitive coating layer using a patterned mask, and d) developing the exposed photosensitive coating layer, and then drying and firing it.

The photosensitive paste may be prepared by mixing the electrically conductive metal, the chromophore element, a photosensitive vehicle, and glass frit. In an implementation, the following proportions may be used: about 65 to about 70 wt % of the electrically conductive metal and about 3 to about 7 wt % of the glass frit, the glass frit including about 1.0 to about 5.0 wt % of the chromophore element based on the entire weight of the glass frit, with the photosensitive vehicle used for the remainder.

The photosensitive vehicle may include a solvent and a photosensitive component such as a photosensitive monomer, a photosensitive oligomer, or a photosensitive polymer. The photosensitive vehicle may further include a photopolymerization initiator.

The solvent in the photosensitive vehicle may include, e.g., trimethylpentanediol monoisobutyrate (TPM), butylcarbitol (BC), butylcellosolve (BC), butylcarbitol acetate (BCA), a terphenol isomer, toluene, or texanol.

The photosensitive oligomer and the photosensitive polymer may include an oligomer or a polymer with a weight average molecular weight of about 500 to about 100,000, and may be formed by polymerizing at least one compound having a carbon-carbon unsaturated bond to form, e.g., a methacryl polymer, polyester acrylate, trimethylolpropane triacrylate, trimethylolpropane triethoxy triacrylate, a cresol epoxy acrylate oligomer, a polymethylmethacrylate (PMMA)-polymethylacrylate (PMA) copolymer, hydroxypropylcellulose (HPC), ethylcellulose (EC), or polyisobutylmethacrylate (PIBMA).

The photosensitive monomer may be polymerized by ultraviolet (UV) light that hardens the photosensitive paste although, in another implementation may be used. The photosensitive monomer may include an acrylate-based monomer. The polymer may include, e.g., epoxy acrylate, polyester acrylate, methylacrylate, ethylacrylate, n-propylacrylate, isopropylacrylate, n-butylacrylate, sec-butylacrylate, isobutylacrylate, tert-butylacrylate, n-pentylacrylate, allylacrylate, benzylacrylate, butoxyethylacrylate, butoxytriethyleneglycolacrylate, cyclohexylacrylate, dicyclopentanylacrylate, dicyclopentenylacrylate, 2-ethylhexylacrylate, glycerolacrylate, glycidylacrylate, heptadecafluorodecylacrylate, 2-hydroxyethyl acrylate, isobornylacrylate, 2-hydroxypropylacrylate, isodecylacrylate, isooctylacrylate, laurylacrylate, 2-methoxyethylacrylate and methoxyethyleneglycolacrylate, or methoxydiethyleneglycolacrylate.

The photopolymerization initiator may include, e.g., benzophenone, o-benzoylbenzoic acid methyl ester, 4,4-bis(dimethylamino)benzophenone, 4,4-bis(diethylamino)benzophenone, 4,4-dichlorobenzophenone, 4-benzoyl-4-methyldiphenylketone, dibenzylketone, fluorenone, 2,2-diethoxyacetophenone, 2,2-dimethoxy-2-phenylacetophenone, 2-hydroxy-2-methylpropiophenone, p-tert-butyldichloroacetophenone, thioxanthone, 2-methylthioxanthone, 2-chlorothioxanthone, 2-isopropylthioxanthone, diethylthioxanthone, benzyldimethylketal, benzylmethoxyethylacetal, benzoin, benzoinmethylether, benzoinbutylether, anthraquinone, 2-tert-butyl anthraquinone, 2-amylanthraquinone, β-chloroanthraquinone, anthrone, benzanthrone, dibenzosuberone, methyleneanthrone, 4-azidebenzalacetophenone, 2,6-bis(p-azidebenzylidene)cyclohexanone, 2,6-bis(p-azidebenzylidene)-4-methylcyclohexanone, 2-phenyl-1,2-butadione-2-(o-methoxycarbonyl)oxime, 2,3-bis(4-diethylaminobenzal)cyclopentanone, 2,6-bis(4-dimethylaminobenzal)cyclohexanone, 2,6-bis(4-dimethylaminobenzal)-4-methylcyclohexanone, michler's ketone (4,4′-(Dimethylamino)Benzophenone)), 4,4-bis(diethylamino)-benzophenone, 4,4-bis(dimethylamino)chalcone, 4,4-bis(diethylamino)chalcone, p-dimethylaminocinnamylideneindanone, p-dimethylaminobenzylideneindanone, 2-(p-dimethylaminophenylvinylene)-isonaphthothiazole, 1,3-bis(4-dimethylaminobenzal)acetone, 1,3-carbonyl-bis(4-diethylaminobenzal)acetone, 3,3-carbonyl-bis(7-diethylaminocumalin), N-phenyl-N-ethylethanolamine, N-phenylethanolamine, N-tolyldiethanolamine, dimethylaminobenzoic acid isoamyl ester, diethylaminobenzoic acid isoamyl ester, 3-phenyl-5-benzoylthio-tetrazole, or 1-phenyl-5-ethoxycarbonylthio-tetrazole.

The relative proportions of the solvent, the photosensitive component, e.g., the photosensitive monomer, the photosensitive oligomer, and the photosensitive polymer, and the photopolymerization initiator are not particularly limited. The relative proportions may be determined based on, e.g., controlling paste properties such as coating ability and photosensitivity.

The photosensitive paste may also include an additive such as a dispersing agent, an antifoaming agent, an antioxidant, a polymerization inhibitor, a plasticizer, a metal powder, etc. Such additives may be used as necessary, and the amounts thereof may be determined according to generally-known requirements. The photosensitive paste may also include a non-photosensitive resin, e.g., an epoxy-based resin or a cellulose-based resin such as ethyl cellulose, nitro cellulose, etc.

The operations of forming a photosensitive coating layer by coating and drying the photosensitive paste (prepared as described above), exposing the photosensitive coating layer using a patterned mask, and drying and firing the exposed photosensitive coating layer after developing may be performed according to a generally-known process, and will not be described in detail.

### Example Plasma Display Panel

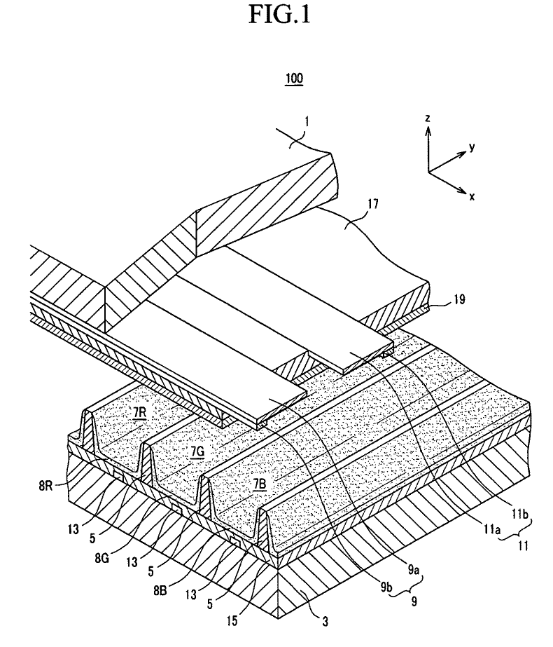

FIG. 1 illustrates an exploded perspective view of a plasma display panel 100 according to an embodiment. Referring to FIG. 1, the plasma display panel 100 may include a first substrate 3, address electrodes 13 disposed in one direction (the y-axis direction in the drawing) on the first substrate 3, and a first dielectric layer 15 covering the address electrodes 13 on the first substrate 3. A barrier rib 5 may be formed among each address electrode 13 on the first dielectric layer 15. A plurality of discharge cells 7R, 7G, and 7B may be formed among each barrier rib 5. The discharge cells 7R, 7G, and 7B may include red (R), green (G), and blue (B) phosphor layers 8R, 8G, and 8B therein.

The barrier rib 5 may have various patterns that partition the discharge spaces. For example, the barrier rib 5 may be an open type, such as a stripe, etc., or a closed type, such as a waffle, a matrix, a delta, etc. The closed type of barrier rib may define discharge spaces having shapes such as a quadrangle, a triangle, a pentagon, a circle, an oval, etc.

A second substrate 1 may include display electrodes 9 and 11. Each of the display electrodes 9 and 11 may include respective transparent electrodes 9a and 11a paired with bus electrodes 9b and 11b. The display electrodes 9, 11 may extend in a direction (x-axis direction in the drawing) crossing the address electrode 13. A second dielectric layer 17 and an MgO protection layer 19 may cover a side of the display electrodes 9 and 11 that faces the first substrate 3.

The discharge cells 7R, 7G, and 7B may be defined where the address electrodes 13 on the first substrate 3 cross the display electrodes 9 and 111 on the second substrate 1.

The bus electrodes 9b and 11b may each be formed as a single layer. Each bus electrode 9b, 11b may include a mixture of a chromophore element and an electrically conductive metal. The chromophore element may include a transition element, a rare earth element metal, or a combination thereof. One or more transition elements may be combined with one or more rare earth element metals. The chromophore element and the electrically conductive metal may be mixed, not in a complete solid solution, but as a mixture.

In an embodiment, the bus electrodes 9b and 11b may include an inorganic binder including glass frit. The chromophore element may color the glass frit, which may be mixed with the electrically conductive metal. A concentration of the glass frit colored with the chromophore element may increase toward the second substrate 1.

The plasma display panel 100 may be operated by applying an address voltage Va between the address electrode 13 and the display electrodes 9, 11 to perform an address discharge, and then applying a sustain voltage (Vs) between the pair of display electrodes 9 and 11 to perform a sustain discharge. The discharge may excite the phosphors using vacuum ultraviolet (VUV) light to emit visible light through the transparent second substrate 1 of the plasma display panel. The plasma display panel 100 may be combined with, e.g., display driving circuits, a power supply, a housing having a bezel, etc., to form a plasma display device, e.g., a television, a computer monitor, an information display device, etc.

The following Examples and Comparative Examples are provided in order to set forth particular details of one or more embodiments. However, it will be understood that the embodiments are not limited to the particular details described.

### Fabrication of a Plasma Display Panel

### COMPARATIVE EXAMPLE 1

A first substrate was fabricated by forming address electrodes on a panel glass, forming a dielectric layer covering the address electrodes, forming barrier ribs on the dielectric layer, and then forming red, green, and blue phosphor layers inside discharge cells partitioned by the barrier ribs using a generally-known method.

For the second substrate, a transparent electrode was prepared by sputtering indium-tin oxide (ITO) on another panel glass and then patterning it. Then, a photosensitive vehicle was prepared, the photosensitive vehicle including 30 parts by weight of a mixed binder including a polymethylmethacrylate (PMMA)-polymethylacrylate (PMA) copolymer, hydroxypropylcellulose (HPC), ethylcellulose (EC), and polyisobutylmethacrylate (PIBMA), 50 parts by weight of a solvent including trimethylpentanediol monoisobutyrate (TPM), butylcarbitol (BC), butylcarbitolacetate (BCA), and a terphenol isomer, 3 parts by weight of 2,2-dimethoxy-2-phenylacetophenone as a photopolymerization initiator, and 17 parts by weight of epoxy acrylate as a photopolymerizable monomer.

For forming a black layer, 30 wt % of the photosensitive vehicle, 65 wt % of ruthenium oxide as a black material, and 5 wt % of a PbO—SiO₂—B₂O₃-based glass frit were mixed to prepare a paste. Then, the paste was coated on the front side of the transparent electrode using a squeegee and dried.

In addition, a white silver paste was prepared by mixing 30 wt % of the photosensitive vehicle, 65 wt % of white Ag, and 5 wt % of a PbO—SiO₂—B₂O₃-based glass frit. The white silver paste was coated on the front side of the transparent electrode using a squeegee and dried.

The electrode layers were exposed to light of 450 mJ/cm² using an exposure device and a photomask having a predetermined pattern. Then, the electrode layers were developed for 25 seconds by spraying a 0.4 wt % sodium carbonate aqueous solution through a nozzle with a pressure of 1.2 kgf/cm² at 35° C. to remove the unexposed part, thus forming electrodes having the predetermined pattern. Then, the pattern was fired at 550° C. for 30 minutes to form a 4 μm-thick patterned bus electrode.

The second substrate was completed by forming a transparent dielectric layer covering the transparent electrode and the bus electrode, and forming an MgO protective layer thereon. The first and second substrates were united together, air was evacuated therefrom, gas was injected therein, and substrates were sealed to prepare a 50-inch plasma display panel.

### Reference Sample

A plasma display panel was fabricated according to the same method as in Comparative Example 1, except for preparing a photosensitive vehicle using a photosensitive paste prepared by mixing 30 wt % of the vehicle, 60 wt % of white Ag, 5 wt % of carbon nanotubes (CNT), and 5 wt % of PbO—SiO₂—B₂O₃-based glass frit, and then fabricating single-layered bus electrodes on the second substrate by coating the paste.

### EXAMPLE 1

A plasma display panel was fabricated according to the same method as in Comparative Example 1, except for preparing a photosensitive vehicle using a photosensitive paste prepared by mixing 29.95 wt % of the vehicle, 65 wt % of white Ag, 0.05 wt % of Ru as chromophore element, and 5 wt % of bismuth-based glass frit, and then fabricating a single-layered bus electrode on the second substrate by coating the paste.

The white Ag had a particle size (D50) of 1.0 μm, and the chromophore element had a particle size (D50) of 0.8 μm.

### EXAMPLE 2

A plasma display panel was fabricated according to the same method as in Example 1, except for coloring the glass frit by mixing the chromophore element therein using a wet blending method, and then preparing a photosensitive paste using the glass frit colored with the chromophore element.

### EXAMPLE 3

A plasma display panel was fabricated according to the same method as in Comparative Example 1, except for preparing a photosensitive vehicle using a photosensitive paste prepared by mixing 29.85 wt % of the vehicle, 65 wt % of white Ag, 0.05 wt %, respectively, of Ru, Ce, and Sc as chromophore element, and 5 wt % of bismuth-based glass frit, and then fabricating a single-layered bus electrode on the second substrate by coating the paste.

The white Ag had a particle size (D50) of 1.0 μm, and the chromophore element had a particle size (D50) of 0.8 μm.

Examination of Bus Electrode with Scanning Electron Microscope (SEM)

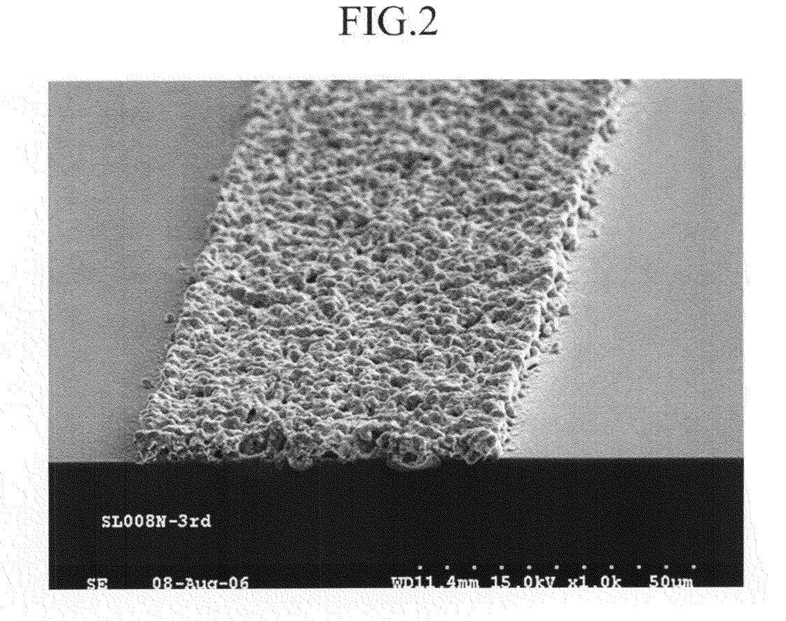

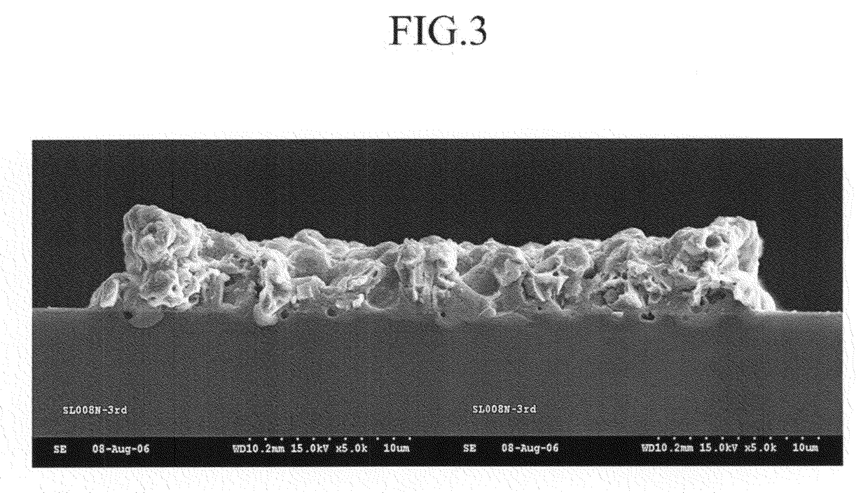

The bus electrode prepared according to Example 2 was examined with a scanning electron microscope (SEM). The results are shown in FIGS. 2 and 3. FIG. 2 illustrates a SEM photograph of the top of a bus electrode of Example 2 according to an embodiment. FIG. 3 illustrates a SEM photograph of a cross-sectional view of the bus electrode of FIG. 2. Referring to FIGS. 2 and 3, the bus electrode of Example 2 was formed as a single layer, in which glass frit colored with a chromophore element was disposed toward the second substrate.

### Performance Evaluation of Plasma Display Panel

The plasma display panels fabricated according to Comparative Example 1, the Reference Sample, and Example 2 were measured with respect to resistance, darkness, and external light luminance of the bus electrodes therein. The results are shown in the following Table 1.

The resistance of the bus electrode was measured through line-resistance after contacting both ends of the fired bus electrode with a micro-probe using a 34401A® multi-tester (Agilent Technologies). Then, the bus electrode specific resistance was determined by calculating the line-resistance as a function of bus electrode height and line-width.

The darkness was measured by using a CM-2600d® tester (Minolta). The external light luminance was measured by using a CS-1000® tester (Minolta).

TABLE 1

| | Specific | Line resistance | | External light |
|---|---|---|---|---|
| | resistance | (50 inch) | Darkness | luminance |
| | (Ωm) | (Ω) | (L*) | (cd/m²) |
| Comparative | 3.3 × 10⁻⁶ | 80 | 30 | 8.5 |
| Example 1 | | | | |
| Reference | 3.96 × 10⁻⁶ | 105 | 35 | 9.67 |
| Sample | | | | |
| Example 2 | 3.6 × 10⁻⁶ | 88 | 32 | 9.0 |
| Example 3 | 3.5 × 10⁻⁶ | 85 | 48 | 13.0 |

Referring to Table 1, the plasma display panel of the Reference Sample had about 12% increased specific resistance and 1.17 cd/m² (about 13.7%) increased external light luminance, relative to Comparative Example 1. The plasma display panel of Example 2 had about 10% increased specific resistance and 0.5 cd/m² (about 5.8%) increased external light luminance, relative to Comparative Example 1. The plasma display panel of Example 3 had about 6% increased specific resistance and 4.5 cd/m² (about 52.9%) increased external light luminance, relative to Comparative Example 1.

In addition to the above tests, the plasma display panels according to Comparative Example 1, the Reference Sample, and Example 2 were measured with respect to luminance and maximum luminance under a full white condition using a CA-100plus® contact brightness meter (Minolta), and were also measured with respect to power consumption. The results are shown in the following Table 2.

TABLE 2

| | | | | Full white |
|---|---|---|---|---|
| | Full white | Maximum | Power | luminance |
| | luminance | luminance | consumption | (390 W calculation) |
| | (cd/m²) | (cd/m²) | (W) | (cd/m²) |
| Comparative | 164.2 | 995.5 | 379.7 | 168.65 |
| Example 1 | | | | |
| Reference | 149.6 | 943.9 | 371.5 | 157.05 |
| Sample | | | | |
| Example 2 | 166.7 | 1,040.2 | 374.5 | 173.60 |

Referring to Table 2, the plasma display panel of Example 2 had excellent full white luminance and maximum luminance compared to those of Comparative Example 1 and the Reference Sample, and much better, i.e., reduced, power consumption relative to Comparative Example 1.

As described above, embodiments may provide a plasma display panel having bus electrodes that include a mixture of a chromophore element and an electrically conductive metal. The bus electrodes may be fabricated in a simple manufacturing process while exhibiting low external light luminance and good electrical conductivity.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display panel, comprising:
a first substrate having a plurality of address electrodes; and
a second substrate having a plurality of display electrodes that include bus electrodes, the first and second substrates being arranged opposite to each other, wherein the bus electrodes include a mixture of a chromophore element and an electrically conductive metal, the chromophore element including at least one of a transition element and a rare earth element metal.

2. The display panel as claimed in claim 1, wherein the chromophore element includes at least one of Co, Fe, Ru, Re, Rh, Os, and Ir as the transition element.

3. The display panel as claimed in claim 1, wherein the chromophore element includes at least one of Sc and Y as the rare earth element metal.

4. The display panel as claimed in claim 1, wherein the electrically conductive metal includes at least one of Ag, Au, Al, Cu, Ni, Cr, Zn, Sn, and an Ag—Pd alloy.

5. The display panel as claimed in claim 1, wherein each bus electrode is a single layer, the single layer including the mixture of the chromophore element and the electrically conductive metal.

6. The display panel as claimed in claim 1, wherein the chromophore element is mixed with the electrically conductive metal as a mixture rather than as a complete solid-solution.

7. The display panel as claimed in claim 1, wherein the electrically conductive metal has a particle size (D50) of about 1 to about 3 μm.

8. The display panel as claimed in claim 1, wherein the chromophore element has a particle size (D50) of about 0.5 to about 2 μm.

9. The display panel as claimed in claim 1, wherein the mixture includes about 0.04 to about 0.6 parts by weight of the chromophore element, based on 100 parts by weight of the electrically conductive metal.

10. The display panel as claimed in claim 1, wherein a concentration of the chromophore element in the bus electrodes increases toward the second substrate.

11. The display panel as claimed in claim 10, wherein about 75 to about 100 wt % of the chromophore element in the bus electrodes is in a lower half-height of the bus electrodes, the lower half-height of the bus electrodes being the half-height closest to the second substrate.

12. The display panel as claimed in claim 1, wherein the bus electrodes further comprise an inorganic binder that includes glass frit.

13. The display panel as claimed in claim 12, wherein the chromophore element is disposed in the glass frit as a colorant, and the colored glass frit is mixed with the electrically conductive metal.

14. The display panel as claimed in claim 13, wherein the glass frit includes about 1 to about 5 parts by weight of the chromophore element, based on 100 parts by weight of the glass frit.

15. The display panel as claimed in claim 13, wherein a concentration of the glass frit colored with the chromophore element in the bus electrodes increases toward the second substrate.

16. The display panel as claimed in claim 15, wherein about 75 to about 100 wt % of the glass frit colored with the chromophore element in the bus electrodes is in a lower half-height of the bus electrodes, the lower half-height of the bus electrode being the half-height closest to the second substrate.

17. The display panel as claimed in claim 12, wherein substantially all of the glass frit colored with the chromophore element is concentrated in a region of the bus electrodes that is closest to the second substrate.

18. The display panel as claimed in claim 17, wherein the region occupies about 8 to about 16% of the height of the bus electrodes.

19. The display panel as claimed in claim 13, wherein the bus electrode comprises about 4 to about 11 parts by weight of the glass frit colored with the chromophore element based on 100 parts by weight of the electrically conductive metal.

20. The display panel as claimed in claim 12, wherein the glass frit includes at least one of a bismuth-based glass frit and a zinc-based glass frit.
